(19) United States
(12) Patent Application Publication
(10) Pub. No.: US 2008/0184790 A1
(43) Pub. Date: Aug. 7, 2008

(54) THERMAL MASS FLOW SENSOR HAVING LOW THERMAL RESISTANCE

(76) Inventors: Jun Ding, Knoxville, TN (US); Reg McCulloch, Caryville, TN (US); Gregory Cox, Oak Ridge, TN (US); Jason Cook, Baxter, KY (US)

Correspondence Address: LUEDEKA, NEELY & GRAHAM, P.C., P O BOX 1871, KNOXVILLE, TN, 37901, US

(21) Appl. No.: 11/834,133

(22) Filed: Aug. 6, 2007

Related U.S. Application Data
(60) Provisional application No. 60/822,807, filed on Aug. 18, 2006.

(51) Int. Cl. G01F 1/68

(52) U.S. Cl. 73/204.25

(57) ABSTRACT

A thermal mass flow measuring apparatus comprises a sheath having an interior surface and a protective exterior surface. A liquid material having a thermal conductivity greater than about 12 w/(m·° C.) is disposed within the sheath in contact with the interior surface of the sheath. A sensor element, such as a thin-film thermoresistive element or a wire-wound thermoresistive element is at least partially submerged in the liquid material. The liquid material, which is preferably liquid metal, decreases the overall thermal resistance between the outer surface of the sheath and the sensor element.

This application claims priority to U.S. provisional patent application No. 60/822,807 filed on Aug. 18, 2006, entitled “LOW THERMAL RESISTANCE SHEATHED THERMAL MASS FLOW SENSOR”, which is incorporated by reference herein in its entirety.

### FIELD

This invention relates generally to fluid flow measuring sensors. More specifically, this invention relates to a thermal-based, fluid flow measuring sensor probe which uses a liquid metal to thermally connect an internal thermoresistive sensor to an external protective sheath immersed in the fluid. This construction minimizes the internal thermal resistance between the sensor and fluid being measured.

### BACKGROUND

Sensors and methods exist for determining the flow rate of fluids, including gasses and liquids, flowing through a system such as a pipe or conduit. However, as discussed below, there are many limitations associated with these flow rate determination sensors and methods.

A thermal mass flow sensor probe immersed in a fluid derives its measurement of the flow rate of that fluid from the heat carried away by the fluid. When the thermoresistive sensor is embedded within a sheath, heat produced by the sensor must flow through several barriers to reach the fluid. Generally, thermal mass flow sensor probes include thermoresistive heating and sensing material that is structurally attached to an alumina or other suitable substrate and covered by a thin glass film. In prior probes, a potting material is typically placed in the region between the sensor and the inside of the metal sheath wall. Heat flux produced by the sensor results in a temperature drop across each material resulting in a lower temperature on the surface of the metal tube. The total temperature drop is equal to the conduction heat transferred from the sensor to the metal sheath surface times the sum of the thermal resistances of each material in the path. This temperature drop, referred to herein as ΔT, is expressed as:

$$Δ T = {T}_{H} - {T}_{S} = {q}_{C} {\sum }_{i = 0}^{n} {R}_{T} ( i ) ,$$

where T_{H}=Temperature of the thermoresistive sensor element (° C.);
T_{S}=Temperature of the surface of the metal sheath (° C.);

q_{C}=Conduction heat transferred through the material (watts); and

R_{T}=Thermal resistance of each material (° C./w).

The higher the thermal resistance of a material, the more the temperature drop across it for a given heat flux. The glass coating over the thermoresistive sensor element is very thin so its R_{T} is small. The greatest R_{T} is commonly encountered in the material contained within the region between the sensor and the inside surface of the metal sheath.

Reduction of the internal temperature drop is important because the driving force for mass flow measurement is the difference between the temperature of the surface of the metal sheath and the ambient temperature of the surrounding fluid. The relationship for convective heat transfer is expressed as:

q_{C}=hA_{S}(T_{S}-T_{A}) where h=heat transfer coefficient (w/cm²° C.); and
T_{A}=fluid ambient temperature (° C.).

As the fluid flow rate increases, h increases so that q_{C} will normally increase. But, if the sensor probe internal thermal resistance is high, internal A_{T} increases with qc, thereby reducing T_{S} and the critical sensor measurement value, T_{S}-T_{A}.

Measurement of mass flow by thermal means in liquids is very demanding because liquid heat transfer properties are generally much higher than in gaseous fluids. As a result, additional heat flux is required. Additionally the metal sheath surface temperature, T_{S}, is often limited to about 20° C. above ambient temperature to preclude anomalous bubble formation. Thus, it is very desirable to limit the internal temperature drop of the sensor probe to maximize heat transfer and maintain good sensitivity at high flow rates.

What is needed, therefore, is a thermal mass flow sensor wherein the thermal resistance between the thermoresistive element and the outer surface of the sensor is minimized.

### SUMMARY

The invention described herein pertains to the improvement in the thermal conductivity between an internal thermoresistive sensor and a protective sheath that encloses the sensor and whose outer surface is in contact with the fluid whose flow rate is to be measured. The entire assembly, referred to herein as a sensor probe, maintains its advantages regardless of the sensor excitation method, whether it be constant current, constant power, constant A_{T} or other means.

In one preferred embodiment, the invention provides a thermal mass flow sensor comprising a protective sheath having an interior surface and a protective exterior surface. A sensor element is disposed within the protective sheath, and a liquid material is disposed within the region between the interior surface of the protective sheath and the sensor element. In a most preferred embodiment, the thermal conductivity of the liquid material is greater than about 12 w/(m° C.).

In another embodiment, the invention provides a thermal mass flow sensor comprising a stainless steel sheath having an interior surface and a protective exterior surface. A liquid metal is disposed within the stainless steel sheath, and a seal is disposed within the sheath to contain the liquid metal. A sensor element, having sensor leads electrically connected thereto, is at least partially submerged in the liquid metal.

In yet another embodiment, the invention provides a thermal mass flow sensor comprising a protective sheath having an interior surface and a protective exterior surface. A sensor element is disposed within the protective sheath. Disposed within the region between the interior surface of the protective sheath and the sensor element are means for providing a thermal path between the sensor element and the interior surface of the protective sheath. In a preferred embodiment, the thermal path has a thermal conductivity greater than about 12 w/(m° C.), with substantially no air gaps between the sensor element and the interior surface of the sheath.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1A depicts a first vertical cross-section of a thermal mass flow sensor according to a first embodiment of the invention;

FIG. 1B depicts a second vertical cross-section of a thermal mass flow sensor according to a first embodiment of the invention, where the second vertical cross-section is perpendicular to the first vertical cross-section;

FIG. 1C depicts a horizontal cross-section through the sensor of FIGS. 1A and 1B taken at section line AA as shown in FIG. 1A;

FIG. 2 depicts a temperature profile of the sensor geometry of FIG. 1B;

FIG. 3A depicts a first vertical cross-section of a thermal mass flow sensor according to a second embodiment of the invention;

FIG. 3B depicts a second vertical cross-section of a thermal mass flow sensor according to the second embodiment of the invention, where the second vertical cross-section is perpendicular to the first vertical cross-section;

FIG. 3C depicts a horizontal cross-section through the sensor of FIGS. 3A and 3B taken at section line AA shown in FIG. 3A;

FIG. 4 depicts a temperature profile of the sensor geometry of FIGS. 3A-3C; and

FIGS. 5A-5C depict a sensor assembly insert.

### DETAILED DESCRIPTION

The thermal resistance, R_{T}, for a cylindrical tube can be expressed as:

$${R}_{T} = \frac{Δ r}{k A} , \qquad ( Eq . 1 )$$

where Δr=mean length of the thermal path (meters);

A=mean area over which heat flux is transferred (m); and

k=material thermal conductivity (w/m° C.).
For a given sensor probe geometry Δr and A are fixed, so k is the significant parameter to optimize. For minimum R_{T}, the thermal conductivity, k, should be as high as possible. As shown in the table below, typical thermal conductivities for different materials can span five orders of magnitude.

| Material | Thermal Conductivity, k, in w/(m ° C.) |
|---|---|
| metals | 50-415 |
| liquid metal | 12-120 |
| non-metal liquids | 0.17-0.7 |
| thermal isolators | 0.03-0.17 |
| gases | 0.007-0.17 |

Based on its high thermal conductivity, metal is the best candidate for the material filling the region between the sensor element and the inside surface of the metal sheath. However, it is difficult to fill the sensor inner region with solid metal without leaving air gaps between the sensor element and the metal filler and between the metal filler and the inner surface of the sheath. Since the thermal conductivity of air is ten thousand times less than metal, the presence of air gaps greatly increase the total R_{T}. If solid metal is forced into place to close the air gaps, the sensor element may be damaged or stressed to such an extent that its coefficient of resistance is adversely affected, thereby rendering it unacceptable for use as a flow rate sensor.

According to various embodiments of the present invention, the use of liquid metal to fill the gap between the sensor element and inside wall of the protective sheath overcomes these limitations. Liquid metal, which has high thermal conductivity and low thermal resistance, significantly reduces the internal temperature drop as compared to prior filler materials. The preferred liquid metal filler is a gallium, indium, tin eutectic alloy (GIT). However, any metal that remains in the liquid state in all operational conditions of the probe can be used. Other candidate materials include but are not limited to mercury, potassium, sodium, and sodium-activated potassium (KNa).

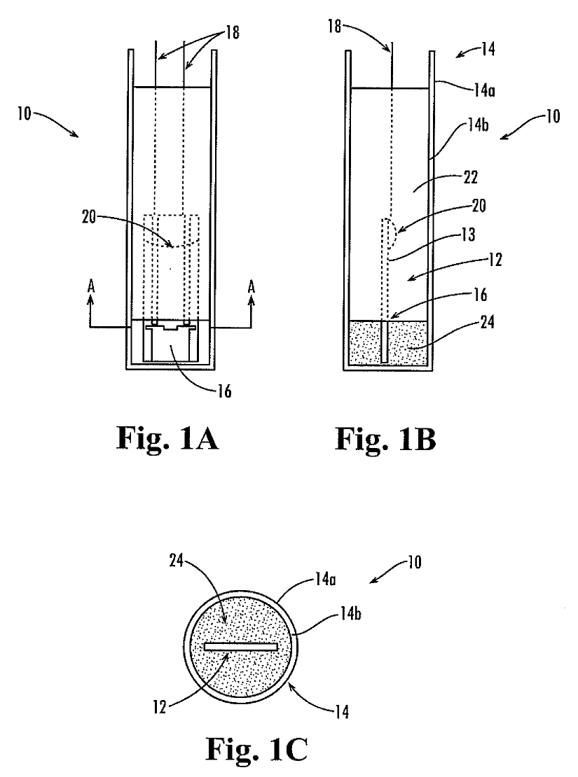

Referring to FIGS. 1A and 1B, a thermal mass flow sensor 10 comprises a sensor assembly 12 disposed within a protective sheath 14. The sheath 14 has a protective exterior surface 14a and an interior surface 14b. In a preferred embodiment, the sheath 14 is an elongate cylinder composed of a metal material, such as stainless steel. However, other materials could be used to construct the sheath, such as graphite composite materials and other high temperature tolerant materials.

The sensor assembly 12 comprises a sensor substrate 13, a thermoresistive sensor element 16 disposed on the substrate 13, and electrical leads 18 that are electrically connected to the sensor element 16. The sensor leads 18 are for passing an electrical current through the sensor element 16 to heat the sensor element 16 and detect the electrical resistance of the sensor element 16. Preferably, the sensor leads 18 extend down the center of the thermal mass flow sensor 10 and through a low-conductivity seal 22 disposed within the protective sheath 14. In a preferred embodiment, the low-conductivity seal 22 comprises an epoxy material. A glass seal 20 is disposed on the sensor substrate 13. The sensor element 16 may be any of a number of different types of heat sensors. In the exemplary embodiment, the sensor element 16 is a thin film type thermoresistive heater/sensor. However, it will be appreciated that the invention is not limited to any particular type of heat sensor.

Disposed below the low-conductivity seal 22 and within the region between the sensor element 16 and the interior surface 14a of the protective sheath 14, there is a cavity that is completely filled with a filler material 24. In preferred embodiments, the filler material 24 is a liquid having a thermal conductivity greater than about 12 w/(m° C.). In one preferred embodiment, the filler material 24 is a liquid metal, such as a Gallium, Indium, Tin eutectic alloy (GIT). Other candidates for the filler material 24 include but are not limited to mercury, potassium, sodium, and sodium-activated potassium (KNa).

The thin film type thermoresistive sensor assembly 12 shown in FIGS. 1A-1C functions to raise the temperature of the sensor element 16 and the filler material 24 surrounding the sensor element 16. Heat from the filler material 24 is dissipated through the protective sheath 14 to the surrounding outside environment which comprises the flowing fluid material. The heat transfer from the filler material 24 to the flowing fluid is proportional to the mass flow rate of the fluid. Thus, the mass flow rate of the flowing fluid will be proportional to the sensed temperature of the thin film type thermoresistive sensor element 16.

In a typical application, the thermal mass flow sensor 10 may also be used to monitor the ambient temperature of a surrounding fluid. In this application, the sensor 10 is in the flow, but very little heat is generated by the sensor. Further discussion of this process is presented in U.S. Pat. No. 6,450,024, entitled “FLOW SENSING DEVICE”, which is incorporated by reference herein in its entirety.

In yet another embodiment of the invention, an additional sensor is provided at the top of the thermal mass flow sensor 10 to directly measure the stem gradient. This information is provided to an algorithm that compensates for stem loss to improve sensor probe performance. If needed, the additional sensor can be used to measure the ambient temperature at the base of the thermal mass flow sensor 10.

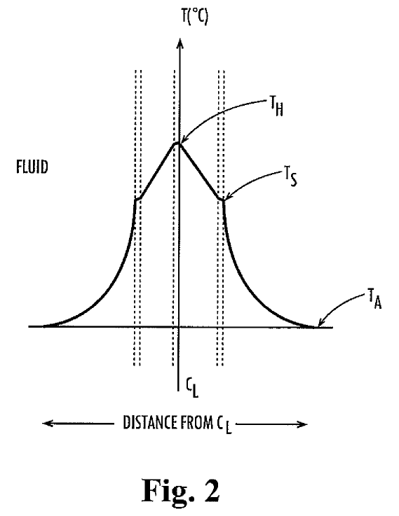

Referring to FIG. 2, there is shown a temperature profile diagram of the thermal mass flow sensor 10 depicted in FIGS. 1A-1C. In FIG. 2, T_{H} represents the temperature of the sensor element 16 which is determined by measuring the resistance of the sensor element 16. The temperature T_{S} is the temperature of the outer surface 14b of the protective sheath 14. (See FIG. 1B.) The temperature T_{A} is the ambient temperature of the fluid in which the thermal mass flow sensor 10 is disposed. The temperature relationship between T_{H} and T_{A} may be determined for particular fluids and different temperatures and different flow rates. Thus, using appropriate calibration curves, T_{H} may be directly related to the flow rate of fluid, and by measuring T_{H} one can determine the flow rate of the fluid.

Other applications for this type of thermal mass flow sensor 10 include fluid level sensors. In a level sensor application, the thermoresistive heater/sensor element 16 is typically elongated. The level of the fluid may be determined by observing T_{H}. If the sensor 10 is partially uncovered, T_{H} will be higher. If it is fully covered, T_{H} will be at a minimum. Every level of the fluid between fully covered and fully uncovered will produce a different T_{H} which may be correlated to the level of the fluid by calibration techniques.

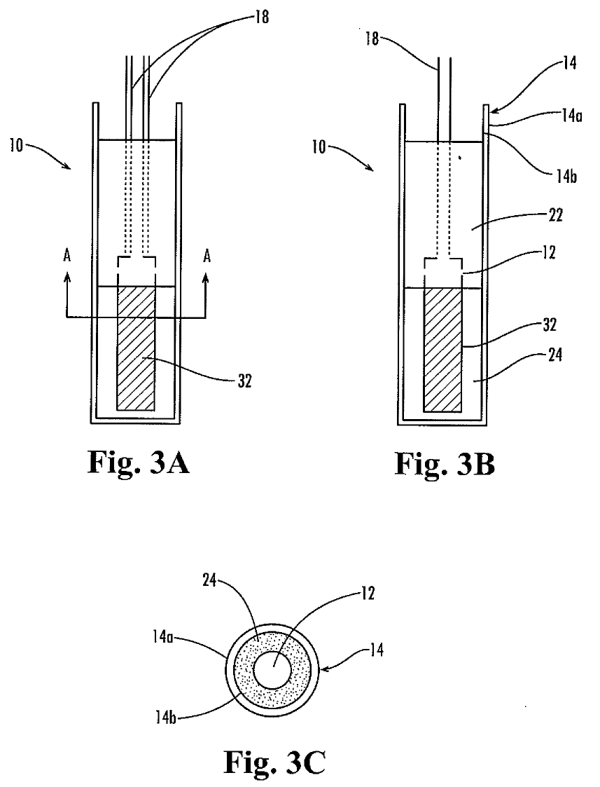

FIGS. 3A, 3B and 3C depict a second embodiment of the invention wherein the thermal mass flow sensor 10 includes a wire-wound thermoresistive sensor element 32 disposed within an elongate protective sheath 14. As in the embodiment described previously, the protective sheath 14 has an exterior surface 14a and an interior surface 14b and is preferably composed of a metal material, such as stainless steel. The sensor assembly 12 comprises a wire-wound thermoresistive sensor element 32 and electrical leads 18 that are electrically connected to the sensor element 32. The wire-wound thermoresistive sensor element 32 of this embodiment generally performs the same functions as discussed above with respect to the thin film type thermoresistive sensor element 16. The sensor leads 18 are for passing an electrical current through the sensor element 32 to heat the sensor element 32 and detect the electrical resistance of the sensor element 32. Preferably, the sensor leads 18 extend down the center of the thermal mass flow sensor 10 and through a low-conductivity seal 22 disposed within the protective sheath 14. In a preferred embodiment, the low conductivity seal 22 comprises an epoxy.

As in the first embodiment described above, disposed below the low conductivity seal 22 and within the region between the wire-wound thermoresistive sensor element 32 and the interior surface 14a of the protective sheath 14, is a cavity that is completely filled with a filler material 24 having a thermal conductivity greater than about 12 w/(m° C.). In the preferred embodiment, the filler material 24 is a liquid metal, such as a Gallium, Indium, Tin eutectic alloy (GIT). Other candidates for the filler material 24 include but are not limited to mercury, potassium, sodium, and sodium-activated potassium (KNa).

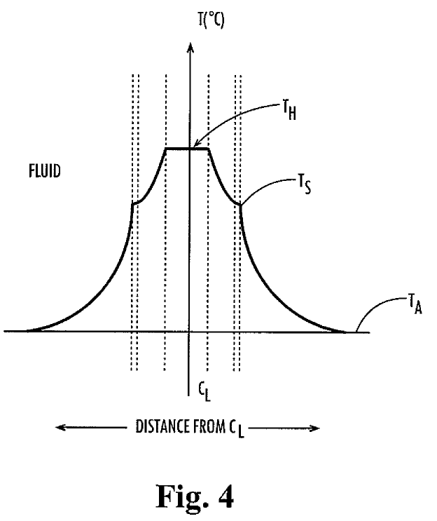

Referring to FIG. 4, there is shown a temperature profile diagram for a thermal mass flow sensor 10 having the wire wound thermoresistive sensor element 32. The temperature profile diagram is interpreted as discussed above with respect to the temperature profile diagram shown in FIG. 2.

It will be appreciated that the invention is not limited to thin-film type thermoresistive sensors and wire-wound thermoresistive sensors. The invention also pertains to thermistors, as well as any sensor or sensor combination that may benefit from reduced internal thermal resistance, such as a thermoresistive sensor with a separate heater. Sensors that do not have an electrical insulating material over the element, such as bare wire wound resistance temperature detectors (RTD's), must be coated for protection as part of the fabrication process.

The basic concept of the sensor may be applied to any type of sensor that requires efficient heat transfer from a sensor to the external surface of a probe. In this embodiment, a heated sensor is used, but in other embodiments, non-heated sensors may be employed.

A further aspect of this invention is the use of materials and fabrication processes which increase thermal resistance of the portion of the sensor probe that extends above the filler material 24 so that heat loss to that portion of the sensor probe is minimized. The portion of the sensor probe that extends above the filler material 24 is also referred to herein as the stem. A major portion of the heat loss in the probe is conducted up the sheath 14. However, since the surface of the sheath is in the fluid being measured, that heat is quickly transferred to the fluid and does not conduct up the stem.

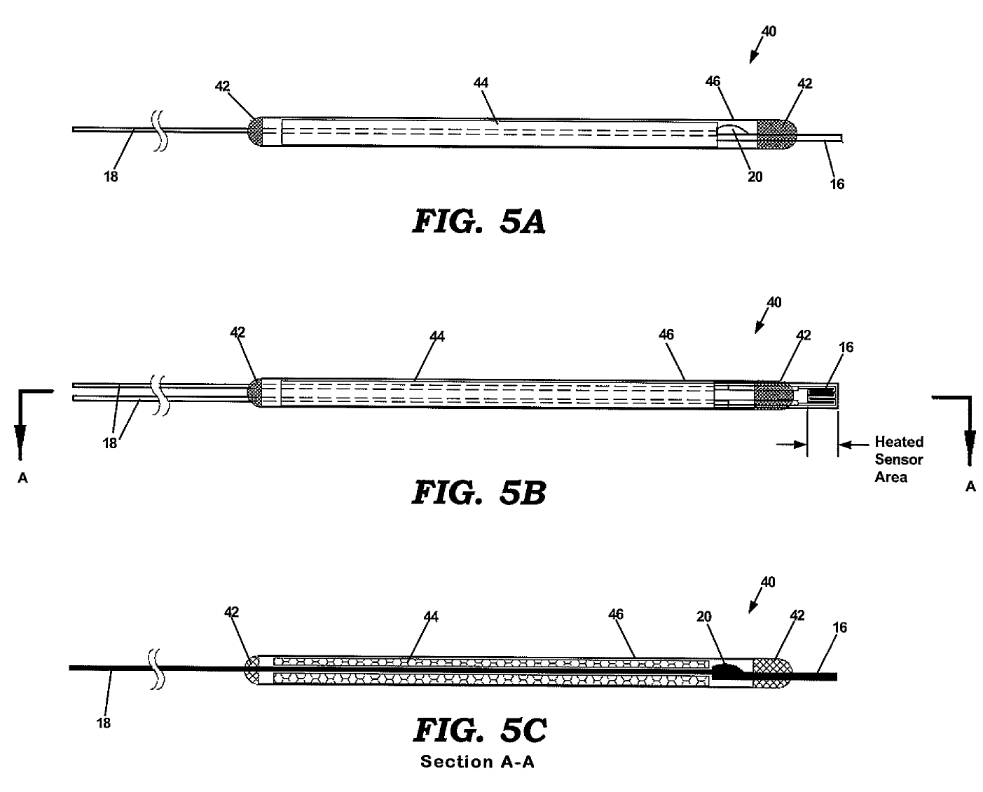

FIGS. 5A-5C depict a preferred embodiment of a sensor assembly insert 40, which comprises components of the sensor probe 10 that are disposed within the sheath 14. The sheath 14 is not shown in FIGS. 5A-5C to simplify the depiction of the sensor assembly insert 40. Heat loss in the stem portion of the sensor assembly insert 40 is minimized by:
(1) maximizing the ratio of stem length to stem diameter (L/d);
(2) minimizing conductor cross-sectional area in the leads 18;
(3) providing a low-conductivity preform 44, preferably made of ceramic, to contain the leads 18 and provide structural support; and
(4) providing a sleeve 46 over the preform 44, preferably made of a polyimide film such as Kapton™, to provide a pocket at the top of the sensor that is filled with a low thermal conductivity sealer material 42, such as epoxy. With this construction, the sensor assembly insert 40 may be assembled independently of the rest of the probe 10, then loaded into the sheath 14 with a coating of epoxy to seal it in place and contain the filler material 24.

The foregoing description of preferred embodiments of this invention has been presented for purposes of illustration and description. The examples provided are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A thermal mass flow measuring apparatus comprising:
a sheath having an interior surface and a protective exterior surface;
a liquid material disposed within the sheath and contacting the interior surface thereof, the liquid material having a thermal conductivity greater than about 12 w/(m·° C.); and
a sensor element at least partially submerged in the liquid material.

2. The thermal mass flow measuring apparatus of claim 1 wherein the sheath comprises a metal material.

3. The thermal mass flow measuring apparatus of claim 2 wherein the metal material comprises stainless steel.

4. The thermal mass flow measuring apparatus of claim 1 further comprising sensor leads connected to the sensor element, the sensor leads for passing an electrical current through the sensor element for heating the sensor element and detecting electrical resistance of the sensor element.

5. The thermal mass flow measuring apparatus of claim 1 further comprising a seal disposed within the sheath for containing the liquid material therein.

6. The thermal mass flow measuring apparatus of claim 1 wherein the sensor element comprises a thin film type thermoresistive sensor.

7. The thermal mass flow measuring apparatus of claim 1 wherein the sensor element comprises a wire-wound thermoresistive sensor.

8. The thermal mass flow measuring apparatus of claim 1 wherein the liquid material comprises a liquid metal.

9. The thermal mass flow measuring apparatus of claim 1 wherein the liquid material comprises an alloy of Gallium, Indium, and Tin.

10. The thermal mass flow measuring apparatus of claim 1 wherein the liquid material comprises a material selected from the group consisting of Mercury, Potassium, Sodium, and Sodium-activated Potassium.

11. A thermal mass flow measuring apparatus comprising: a stainless steel sheath having an interior surface and a protective exterior surface; liquid metal disposed within the stainless steel sheath and contacting the interior surface thereof,
a seal disposed within the stainless steel sheath for containing the liquid metal;
a sensor element at least partially submerged in the liquid metal; and
sensor leads electrically connected to the sensor element.

12. The thermal mass flow measuring apparatus of claim 11 wherein the sensor element comprises a thin film type thermoresistive sensor.

13. The thermal mass flow measuring apparatus of claim 11 wherein the sensor element comprises a wire-wound thermoresistive sensor.

14. The thermal mass flow measuring apparatus of claim 11 wherein the liquid metal comprises an alloy of Gallium, Indium, and Tin.

15. The thermal mass flow measuring apparatus of claim 11 wherein the liquid metal comprises a material selected from the group consisting of Mercury, Potassium, Sodium, and Sodium-activated Potassium.

16. A thermal mass flow measuring apparatus comprising: a sheath having an interior surface and a protective exterior surface; a sensor element disposed within the sheath; and means for providing a thermal path between the sensor element and the interior surface of
the sheath, the means for providing a thermal path having a thermal conductivity greater than about 12 w/(m·° C.) and having substantially no air gaps between the sensor element and the interior surface of the sheath.

17. The thermal mass flow measuring apparatus of claim 16 wherein the means for providing a thermal path include a liquid metal.

18. The thermal mass flow measuring apparatus of claim 16 wherein the means for providing a thermal path include an alloy of Gallium, Indium, and Tin in liquid form.

19. The thermal mass flow measuring apparatus of claim 16 wherein the means for providing a thermal path include a material selected from the group consisting of Mercury, Potassium, Sodium, and Sodium-activated Potassium.

20. A thermal mass flow measuring apparatus comprising:
a sheath having an interior surface and a protective exterior surface;
a sensor assembly insert disposed at least partially within the sheath, the sensor assembly insert comprising:
a sensor element for sensing temperature characteristics;
sensor leads connected to the sensor element;
an elongate preform surrounding and supporting the sensor leads;
an elongate protective sleeve surrounding the preform; and
a sealer material disposed between the protective sleeve and the sensor leads at one end of the protective sleeve and disposed between the protective sleeve and the sensor element at an opposing end of the protective sleeve.
a filler material disposed within the sheath between the sensor element and the interior surface of the sheath

21. The thermal mass flow measuring apparatus of claim 20 wherein the preform is constructed of a ceramic material.

22. The thermal mass flow measuring apparatus of claim 20 wherein the protective sleeve is constructed of a polyimide material.

23. The thermal mass flow measuring apparatus of claim 20 wherein the sealer material comprises an epoxy.

24. The thermal mass flow measuring apparatus of claim 20 wherein the filler material comprises a liquid having a thermal conductivity greater than about 12 w/(m·° C.).
